(19) United States
(12) Patent Application Publication
(10) Pub. No.: US 2005/0057434 A1
(43) Pub. Date: Mar. 17, 2005

(54) Multi screen display system and control method thereof

(75) Inventor: Hung-Soo Youn, Seoul City (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/833,332

(22) Filed: Apr. 28, 2004

(30) Foreign Application Priority Data
Aug. 30, 2003 (KR) 2003-60601

(51) Int. Cl. G09G 5/00

(52) U.S. Cl. 345/1.3

(57) ABSTRACT

A multi-screen display system comprises a plurality of display devices being adjacent to each other to allow pictures displayed on respective screens thereof to form a whole picture, wherein each of the display devices displays at least one area of the whole picture by adjusting the size and the position of the whole picture. With this configuration, the present invention provides a multi-screen display system and a control method thereof, which decrease a production cost thereof and improve extendability of a display device.

### CROSS-REFERENCE TO RELATED APPLICATIONS

This application is based on and claims priority from Korean Patent Application No. 2003-60601, filed Aug. 30, 2003, in the Korean Intellectual Property Office, the disclosure of which is incorporated herein by reference.

### BACKGROUND OF THE INVENTION

1. Field of the Invention

The present invention relates to a multi-screen display system and a control method thereof, and more particularly, to a multi-screen display system and a control method thereof, which improve extendability of a display device.

2. Description of the Related Art

In a multi-screen display system, a plurality of display devices are adjacent to each other to form a single large screen. That is, the multi-screen display system displays a single large picture by displaying parts of the single picture on each of the plurality of display devices. Such multi-screen display system is mainly used as a wide screen in a performance place, an exhibit hall, etc.

FIG. 1 is a control block diagram of a conventional multi-screen display system. As shown therein, a conventional multi-screen display system 100 comprises a video signal source 700 outputting a video signal, a plurality of display devices 200, 300, 400 and 500, and a display controller 600.

The display devices 200, 300, 400 and 500 are adjacent to each other, so that respective pictures displayed on screens of the display devices 200, 300, 400 and 500 form a single whole picture. FIG. 1 illustrates an example of four display devices arranged in a 2×2 configuration, but the display devices may-be arranged in other configurations, such as 1×2, 3×3, etc., as necessary.

The video signal source 700, for example, a computer outputs the video signal corresponding to the whole picture-to the display controller 600.

The display controller 600 divides/converts the video signal received from the video signal source 700 into video signals corresponding to the parts of the single whole picture and transmits the video signals to the respective display devices 200, 300, 400 and 500, thereby allowing the display devices 200, 300, 400 and 500 to display the parts of the single picture, respectively. For example, in the multi-screen display system 100 comprising four display devices 200, 300, 400 and 500 arranged in the 2×2 configuration as shown in FIG. 1, when the display devices 200, 300, 400 and 500 vertically and horizontally divide the single whole picture into four parts to display respective pictures of the parts, the display controller 600 applies a time axis transform to the video signal received from the video signal source 700 and controls the screen of the upper left display device 200 to be filled with forward halves of vertical and horizontal scanning periods of the video signal corresponding to the whole picture. Similarly, the screen of the upper right display device 300 is filled with a backward half of the horizontal scanning period and a forward half of the vertical scanning period of the video signal corresponding to the whole picture. Likewise, the time axis transform is applied to the lower right and left display devices 400 and 500to display lower right and left parts of the whole picture on the screens thereof, respectively.

Thus, in the conventional multi-screen display system 100, the video signals transmitted to the respective display devices 200, 300, 400 and 500 are different from each other. That is, in the conventional multi-screen display system 100, the display controller 600 receives the video signal corresponding to the whole picture from the video signal source 700 and applies the time axis transform to the video signal corresponding to the whole picture, thereby transmitting the video signals corresponding to the parts of the whole picture to the respective display devices 200, 300, 400 and 500.

However, in the conventional multi-screen display system 100, the display controller 600 employed for converting the video signal output from the video signal source 700 into the video signals corresponding to the parts of the whole picture to be displayed by the respective display device 200, 300, 400 and 500 is complicated and expensive, thereby increasing a production cost of the multi-screen display system 100.

Further, in the conventional multi-screen display system 100, the display controller 600 can support a limited number of the display devices. For example, if two display devices are added to the multi-screen display system 100 shown in FIG. 1 comprising four display devices 200, 300, 400 and 500, the display controller 600 should be replaced with the display controller capable of supporting six display devices or be provided with an extending card additionally to support the added display devices.

### SUMMARY OF THE INVENTION

Accordingly, it is an aspect of the present invention to provide a multi-screen display system and a control method thereof, which decrease a production cost thereof and improve extendability of a display device.

Additional aspects and/or advantages of the invention will be set forth in part in the description which follows and, in part, will be obvious from the description, or may be learned by practice of the invention.

The foregoing and/or other aspects of the present invention are achieved by providing a multi-screen display system comprising: a plurality of display devices being adjacent to each other to allow pictures displayed on respective screens thereof to form a whole picture, wherein each of the display devices displays at least one area of the whole picture by adjusting the size and the position of the whole picture.

According to an aspect of the invention, the multi-screen display system further comprises a signal distributor receiving a video signal corresponding to the whole picture and transmitting the video signal to the respective display devices.

According to an aspect of the invention, each display device comprises a display part displaying a picture thereon; a signal processor converting the video signal received from the signal distributor into a video signal suitable to be processed by the display part; and a controller controlling the signal processor to convert the video signal received from the signal distributor on the basis of previously set size and position variables.

According to an aspect of the invention, the display device comprises one among a digital light processing (DLP), a liquid crystal display (LCD) and a plasma display panel (PDP).

According to an aspect of the invention, the multi-screen display system further comprises a computer outputting the video signal to the signal distributor.

According to an aspect of the invention, the computer is capable of setting up a size variable to adjust the size of the picture displayed by each display device, and setting up a position variable to adjust the position of the picture displayed by each display device.

According to an aspect of the invention, the computer sets up the size and position variables of each display device through an RS-232C interface or an RS-422 interface.

According to an aspect of the invention, each display device comprises an on screen display (OSD) generator generating an OSD interface to set up the size variable to adjust the size of the picture displayed by each display device, and to set up the position variable to adjust the position of the picture displayed by each display device.

According to an aspect of the invention, the OSD interface allows to divide the whole picture into N×M cells, select one of the N×M cells, and set up the size and position variables of each display device, and each display device displays the picture corresponding to the cell selected through the OSD interface among the pictures corresponding to the video signals transmitted from the signal distributor.

According to another aspect of the present invention, the above and/or other aspects may be also achieved by providing a method of controlling a multi-screen display system comprising a plurality of display device being adjacent to each other to allow pictures displayed on respective screens thereof to form a whole picture, the method comprising: setting up a size variable to adjust the size of the picture displayed by each display device and a position variable to adjust the position of the picture displayed by each display device; transmitting a video signal to the respective display devices to form the whole picture; and controlling the video signals transmitted to the respective display devices on the basis of the set size and position variables to allow each display device to display at least one area of the whole picture corresponding to the received video signal.

According to an aspect of the invention, the method further comprises transmitting the video signal from a video signal source to each display device.

According to an aspect of the invention, the setting up the size and position variables comprises dividing the whole picture into N×M cells, and selecting one of the N×M cells; and setting up the size and position variables corresponding to the selected cell.

### BRIEF DESCRIPTION OF THE DRAWINGS

These and other aspects and advantages of the present invention will become apparent and more readily appreciated from the following description of the embodiments, taken in conjunction with the accompany drawings of which:

FIG. 1 is a control block diagram of a conventional multi-screen display system;

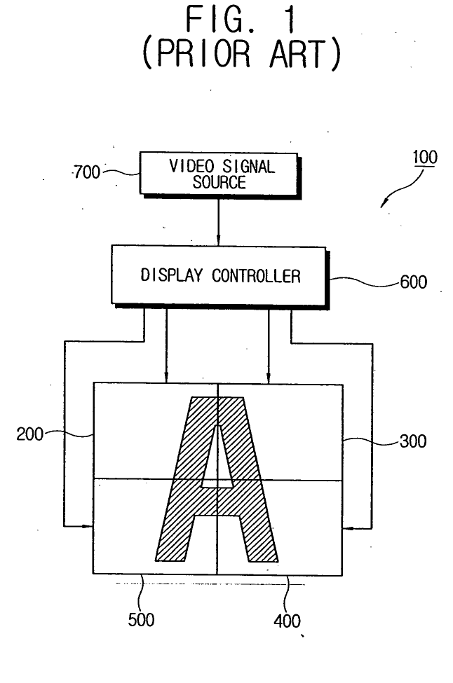

FIG. 2 is a control block diagram of a multi-screen display system according to an embodiment of the present invention;

FIG. 3 illustrates a picture displayed on a first display device in the multi-screen display system of FIG. 2;

FIG. 4 is a control block diagram of each display device in the multi-screen display system of FIG. 2; and

FIG. 5 illustrates the multi-screen display system comprising a plurality of display devices.

### DETAILED DESCRIPTION OF THE PREFERRED EMBODIMENT

Reference will now be made in detail to the embodiments of the present invention, examples of which are illustrated in the accompanying drawings, wherein like reference numerals refer to like elements throughout. The embodiments are described below in order to explain the present invention by referring to the figures.

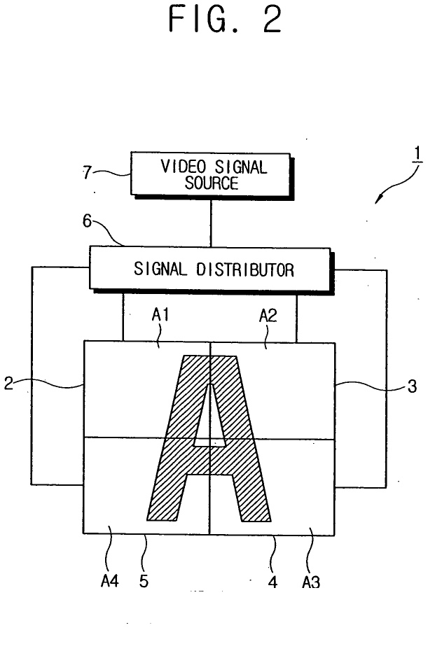

As shown in FIG. 2, a multi-screen display system 1 according to an embodiment of the present invention comprises a plurality of display devices 2, 3, 4 and 5, and a signal distributor 6.

The signal distributor 6 receives a video signal corresponding to a single picture (hereinafter, referred to as the “whole picture”) from a video signal source 7, and outputs a video signal corresponding to the whole picture to the respective display devices 2, 3, 4 and 5. That is, the video signals transmitted from the signal distributor 6 according to the embodiment of the present invention to the respective display devices 2, 3, 4 and 5 are equivalent to one another in being employed as a video signal to display the whole picture.

The respective display devices 2, 3, 4 and 5 are adjacent to each other, so that the respective pictures displayed on screens of the display devices 2, 3, 4 and 5 form the whole picture. In this embodiment, the multi-screen display system 1 comprising four display devices 2, 3, 4 and 5 arranged in a 2×2 configuration as shown in FIG. 2 will be described by way of example. The upper left display device is defined as a first display device 2 and the other display devices are respectively defined as second, third and fourth display devices 3, 4 and 5 in a clockwise direction from the first display device 2 to help understanding of the invention. Further, in this embodiment, the display devices 2, 3, 4 and 5 vertically and horizontally divide the whole picture into four parts to display respective areas of the whole picture by way of example. Here, the four parts of the whole picture will be respectively defined as a first area A1, a second area A2, a third area A3 and a fourth area A4 in the clockwise direction from the upper left part.

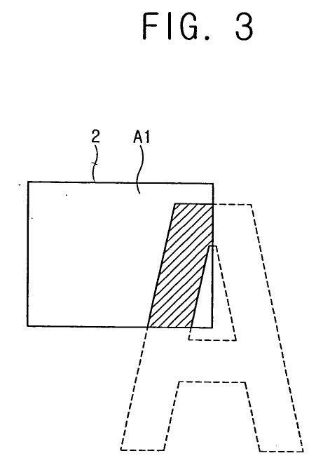

The display devices 2, 3, 4 and 5 display the first, second, third and fourth areas of the whole picture by adjusting the size and the position of the whole picture, respectively. Each of the display devices 2, 3, 4 and 5 adjusts size and position variables to previously set size and position variables to control the size and the position of the picture displayed on its screen, thereby displaying the partial area of the whole picture. Referring to FIG. 3, as the video signal corresponding to the whole picture “A” is input to the first display device 2, the first display device 2 increases the vertical and horizontal sizes of the whole picture twice and adjusts an upper left corner of the twice enlarged whole picture to be aligned with an upper left corner of the screen of the first display device 2, thereby displaying only the first area A1 of the whole picture. Likewise, the second, third and fourth display devices 3, 4 and 5 display the second, third and fourth areas A2, A3 and A4 by the above-described method, respectively. Thus, the pictures displayed on the screens of the respective display devices 2, 3, 4 and 5 are combined and form the whole picture.

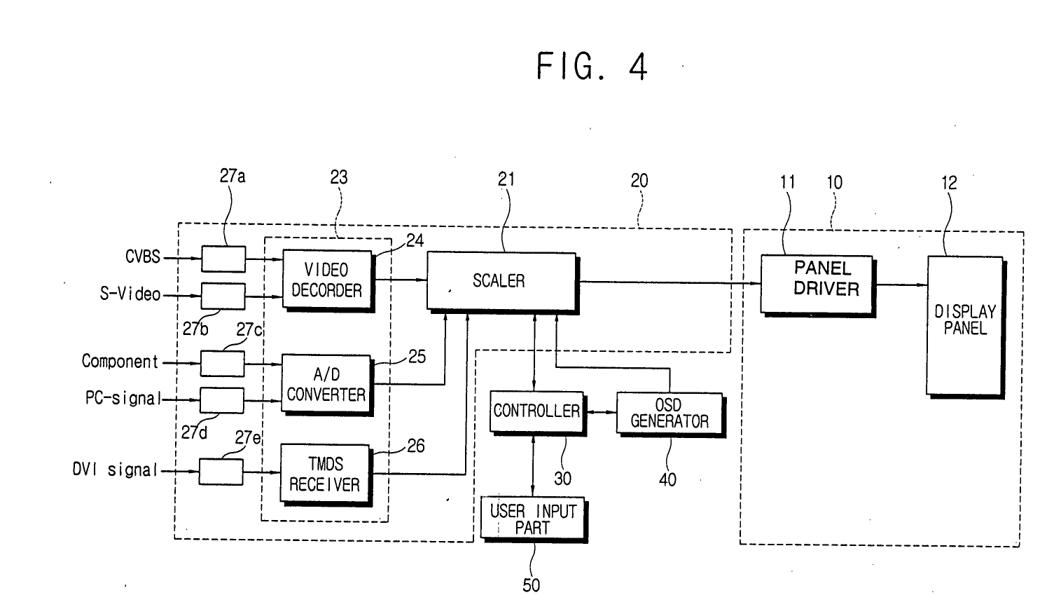

FIG. 4 is a control block diagram of each display device 2, 3, 4 and 5 according to a preferred embodiment of the present invention. As shown therein, each display device 2, 3, 4 and 5 comprises a display part 10, a signal processor 20, and a controller 30.

The display part 10 receives a video signal from the signal processor 20 and displays a picture based on the video signal. The display part 10 comprises a display panel 12 on which a picture is displayed, and a panel driver 11 processing the video signal received from the signal processor 20 and enabling the display panel 12 to display a picture. The display part 10 according to the embodiment of the present invention may includes various different types of displays such as a digital light processing (DLP), a liquid crystal display (LCD), a plasma display panel (PDP), etc., which are capable of adjusting the size and the position of the picture. In the case of employing the DLP as the display part 10, the panel driver 11 comprises an optical engine, etc. Accordingly, configuration of the display part 10 and the panel driver 11 may vary according to the type of the display.

The signal processor 20 converts the video signal received from the signal distributor 6 into the video signal suitable to be processed by the display part 10. The signal processor 20 according to the embodiment of the present invention comprises a scaler 21 adjusting the size and position variables of the video signal, being controlled by the controller 30, and a signal converting part 23 converting the video signal received from the signal distributor 6 into the video signal suitable to be processed by the scaler 21.

The signal converting part 23 comprises at least one of a video decoder 24, an analog/digital (A/D) converter 25, and a transition minimized differential signaling (TMDS) receiver 26.

The video decoder 24 decodes an analog signal such as composite video broadcast signal (CVBS), S-video signal, etc. input through an analog connection terminal and transmits the decoded analog signal to the scaler 21. The display device 2, 3, 4 and 5 comprises input terminals for receiving the analog signal such as a CVBS connection terminal 27a and an S-video connection terminal 27b through which the CVBS and the S-video signal are input.

The A/D converter 25 converts an analog video signal such as a component signal, a PC video signal, etc. input through a component connection terminal 27c or a personal computer (PC) connection terminal 27d into a digital video signal and transmits the digital video signal to the scaler 21.

The TMDS receiver 26 divides a digital video signal such as a digital visual interface (DVI) video signal, etc. input through a DVI connection terminal 27e into a red, green and blue (RGB) digital signal and a horizontal/vertical (H/V) synchronous signal.

Further, each of the display devices 2, 3, 4 and 5 comprises an on screen display (OSD) generator 40 generating an OSD interface through which a user can adjust the size and position variables to control the sizes and the positions of the pictures displayed on the screens of the respective display devices 2, 3, 4 and 5. Thus, a user can control the partial areas of Ache whole picture to be displayed on the screens of the respective display devices 2, 3, 4 and 5 by adjusting-the size and position variables through the OSD interface. Therefore, even if the respective display devices 2, 3, 4 and 5 are changed in arrangement, the partial areas displayed on the screens of the respective display devices 2, 3, 4 and 5 can be controlled to form the whole picture by adjusting the size and position variables through the OSD interface.

Preferably, the OSD interface according to the embodiment of the present invention allows a user to select one of cells corresponding to the partial areas of the whole picture and to adjust the size and position variables of the selected one. For example, the OSD interface provides a user with an interface allowing a user to select one among numerals, e.g., “1”, “2”, “3” and “4” corresponding to the respective partial areas of the whole picture. Then, a user assigns “1”, “2”, “3” and “4” to the first, second, third and fourth display devices 2, 3, 4 and 5, thereby controlling the first, second, third and fourth display devices 2, 3, 4 and 5 to display the first area A1, the second area A2, the third area A3, and the fourth area A4, respectively.

A user selects the partial areas of the whole picture to be displayed by the respective display devices 2, 3, 4 and 5 by using a user input part 50. The user input part 50 may be an OSD control button provided in a side of the multi-screen display system 1, or a remote controller. Here, the size and position variables corresponding to the cells set up through the user input part 50 are stored in a nonvolatile memory (not shown) such as an electrical erasable programmable read only memory (EEPROM), etc.

Further, the multi-screen display system 1 according to the embodiment of the present invention comprises the video signal source 7 outputting the video signal corresponding to the whole picture to the signal distributor 6. The video signal source 7 includes a device such as a video tape recorder (VTR), a digital video disk (DVD) player, etc., which can output the video signal. In this embodiment, a computer is exemplarily employed as the video signal source 7.

Further, in the case of employing the computer as the video signal source 7, the size and position variables of the respective display devices 2, 3, 4 and 5 can be preferably set up by the computer. The computer is connected to the multi-screen display system 1 by an RS-232C interface or an RS-422 interface through which a control signal is transmitted to set up the size variable and the position variable. Here, a method and an interface for setting up the size and position variables may be equivalent to the method and the interface according to the forgoing OSD interface and the OSD generator 40.

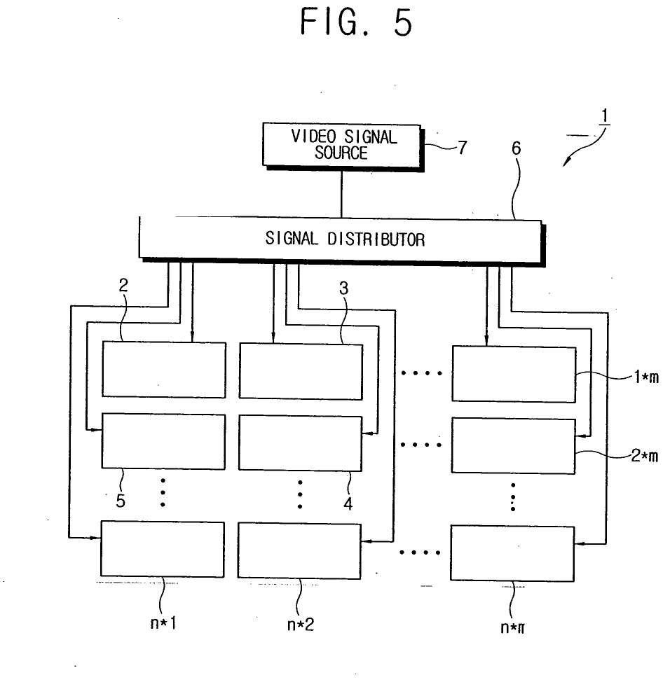

In the above-described embodiment, the multi-screen display system 1 comprises four display devices 2, 3, 4 and 5 arranged in the 2×2 configuration. However, as shown in FIG. 5, the multi-screen display system may comprise N×M display devices arranged in a N×M configuration as long as the respective display devices can adjust the size and the position of the picture display.

Further, in the above-described embodiment, the respective display devices 2, 3, 4 and 5 display the first, second, third and fourth areas A1, A2, A3 and A4 of the whole picture, so that the multi-screen display system 1 display the whole picture “A”. However, when the size variable and the position variable of the respective devices 2, 3, 4 and 5 are controlled through the OSD interface, the multi-screen display system 1 display the whole picture with various formats.

As described above, each of the display devices 2, 3, 4 and 5 displays at least one area of the whole picture by adjusting the size and the position of the picture corresponding to the received video signal, so that there is no need of a separated display controller outputting the video signals corresponding to the partial area of the whole picture to the respective display devices, thereby decreasing a production cost of the multi-screen display system.

Further, as long as the respective display devices can adjust the size and the position of the picture display, the number of the display devices can be increased or decreased without installing an extending card or changing the display controller.

As described above, the present invention provides a multi-screen display system and a control method thereof, which decrease a production cost thereof and improve extendability of a display device.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A multi-screen display system comprising:
a plurality of display devices positioned adjacent to each other so that pictures displayed on respective screens of the display devices form a whole picture,
wherein each of the display devices adjusts a size and a position of the whole picture to display at least a partial area of the whole picture.

2. The multi-screen display system according to claim 1, further comprising a signal distributor receiving a video signal corresponding to the whole picture and transmitting the video signal to the display devices.

3. The multi-screen display system according to claim 2, wherein each of the display devices comprises:
a display part displaying at least the partial area of the whole picture thereon;
a signal processor converting the video signal received from the signal distributor into a video signal suitable to be processed by the display part; and
a controller controlling the signal processor to convert the video signal received from the signal distributor on the basis of previously set size and position variables.

4. The multi-screen display system according to claim 2, wherein each of the display-device comprises a digital light processing (DLP), a liquid crystal display (LCD) or a plasma display panel (PDP).

5. The multi-screen display system according to claim 2, further comprising a computer outputting the video signal to the signal distributor.

6. The multi-screen display system according to claim 5, wherein the computer is configured to set a size variable to adjust the size of the whole picture displayed by each of the display devices, and set a position variable to adjust the position of the partial area of the whole picture displayed by each of the display devices.

7. The multi-screen display system according to claim 6, wherein the computer is configured to set the size and position variables of each display device through an RS-232C interface or an RS-422 interface.

8. The multi-screen display system according to claim 2, wherein each of the display devices comprises an on screen display (OSD) generator generating an OSD interface to set the size variable in order to adjust the size of the whole picture displayed by each of the display devices, and to set up the position variable to adjust the position of the partial area of the whole picture displayed by each of the display devices.

9. The multi-screen display system according to claim 8, wherein the OSD interface is configured to divide the whole picture into N×M cells, select one of the N×M cells, and set up the size and position variables of each of display devices, and
each of the display devices displays the partial area of the whole picture corresponding to a cell selected through the OSD interface.

10. A method of controlling a multi-screen display system comprising a plurality of display devices positioned adjacent to each other so that pictures displayed on respective screens of the display devices form a whole picture, the method comprising:
setting a size variable designating a size of the picture displayed by each of the display devices and a position variable designating a position of the picture displayed by each display device;
transmitting a video signal corresponding to the whole picture to the respective display devices; and
processing the video signal at the respective display devices on the basis of the set size and position variables to adjust the size and position of the picture displayed by each of display devices so that each of the display devices displays at least a partial area of the whole picture corresponding to the video signal.

11. The method according to claim 10, wherein the video signal is transmitted from a video signal source to each of the display devices.

12. The method according to claim 11, wherein the setting the size and position variables comprises:
dividing the whole picture into N×M cells, and selecting one of the N×M cells; and
setting the size and position variables corresponding to the selected cell.
